(19) United States
(12) Patent Application Publication
(10) Pub. No.: US 2017/0228561 A1
(43) Pub. Date: Aug. 10, 2017

(54) SYSTEMS AND METHODS FOR IDENTIFYING RELEVANT PERSONNEL OVER A NETWORK

(71) Applicant: Rene Nathan, Lower Templestowe Victoria (AU)

(72) Inventor: René Nathan, Lower Templestowe (AU)

(21) Appl. No.: 15/496,635

(22) Filed: Apr. 25, 2017

Related U.S. Application Data
(63) Continuation-in-part of application No. 14/431,201, filed on Mar. 25, 2015, now abandoned.
(60) Provisional application No. 61/706,828, filed on Sep. 28, 2012.

(51) Int. Cl. G06F 21/62; G06F 21/30; G06F 17/30

(52) U.S. Cl. CPC G06F 21/6245; G06F 17/30864; G06F 21/305

(57) ABSTRACT

A system for identifying personnel within an organization, which is implemented on a computer network of the organization and includes: (A) a database that connects to the computer network and includes (i) knowledge, skill, experience or information held by one or more personnel of the organization, and (ii) contact details of the one or more personnel; and (B) one or more processor-enabled devices that connect to the computer network. The one or more processor-enabled devices interrogate the database for a desired knowledge, skill, experience or information held, and where the desired knowledge, skill, experience or information is held by one of the one or more personnel the one or more devices is provided with the identification and/or contact details of that personnel. The system may be connected to other business systems such as logistics systems and human resources systems so as to best select and deploy personnel as required.

### CROSS-REFERENCE TO RELATED APPLICATIONS

This application is a Continuation-In-Part application of U.S. patent application Ser. No. 14/431,201, filed Mar. 25, 2015, which is a Section 371 National Stage Application of International Application No. PCT/AU2013/001097, filed Sep. 25, 2013, and published as WO 2014/047683 A1 on Apr. 3, 2014, in English, which claims benefit of U.S. Provisional Patent Application Ser. No. 61/706,828, filed Sep. 28, 2012, the contents of which are hereby incorporated by reference in their entireties.

### FIELD OF THE INVENTION

The present invention relates generally to the field of information management within organizations. In particular, the invention is directed to systems and methods to improve the identification of an individual within an organization capable of addressing a query or a problem, or having desired information.

### BACKGROUND TO THE INVENTION

The so-called “silo effect” is a well-documented problem of larger organizations. Put simply, organizational structures often act to inhibit the flow of information between discrete units within a business, and often even within discrete units. Indeed, it has been proposed that organizations are structured in such a way as to encourage the formation of silos. The manner in which heads within an organization are remunerated, the way in which they manage and report on their business financially, and the way in which key performance indicators are structured encourage a narrow focus. In some instances, silos can be formed or perpetuated deliberately by managers with a view to controlling information

While siloed organizational structures have some advantages in achieving commercial outcomes, negative outcomes are often an undesirable by-product. Restrictions in enterprise thinking, cultural diversity, collaboration, and innovation often result.

There are a number of factors that act to inhibit or prevent the dissemination of information within an organization. For example, embedded cultures may act to limit communication between personnel. Members of a department may tend to mix amongst themselves given their shared vocations, educational backgrounds, and knowledge base.

Geography is a further contributor to the general inhibition of information flow within an organization. Personnel spread across a number of locations do not have the same opportunity to interact as do co-workers housed in a single office building. Even where workers are in a single office, compartmentalization of information may still occur. For example, personnel working on different floors of a multi-story building may have little or no need to visit another floor.

While communication platforms such as the telephone and email are always available, these means are not well used to disseminate information. These modes of communication generally rely on established networks, and are typically useful where two individuals have an existing relationship.

A further problem of the silo effect is that information is concentrated and retained by certain individuals in the capture of knowledge and experience within organizations. When personnel leave, often important information is irretrievably lost to the organization.

There have been attempts to address the problems of silos by the use of facilities analogous to social networking websites such as Facebook™. While allowing for some interaction between personnel in an organization, the solutions of the prior art have a number of shortcomings.

Prior art facilities typically facilitate interaction between individuals in existing networks, such as between staff in a certain location or department, or staff members that have previously met at a company conference. These arrangements do little to identify potentially useful contacts outside an individual's usual network. In addition, prior art facilities may fail to find an individual having a particular set of attributes even where that individual exists in the organization, and is active on the facility.

As mentioned, prior art facilities are based on social networking platforms. As a result, personnel tend toward using these facilities for social interactions within their established networks, leading to decreases in productivity. Many organizations are aware of the problems associated with social networking sites and ban access for personnel.

In addition to the above problems, prior art facilities also have security issues. Companies are typically very security conscious, and strive to keep information “in-house” as far as possible.

Another problem is that organizations are inherently undemocratic, with lower level personnel often not able to interact with higher level managers and executives.

A further problem of many organizations relates to the deployment of appropriate personnel (in the form of one or more workers) to a geographical location in order to effect a required task. Specialist tasks requiring a certain trade, technical ability or certification may be required outside or within the physical confines of the organization. As one example, a telephone company may need to dispatch a group of workers to the location of a service fault. Rectification of the fault may require an excavation crew to expose the cable, a technician to repair the fault, and a traffic controller to divert traffic about the work site. Difficulties can arise in locating a single worker having a required skill, and more so when a group of workers having expertise across different areas is required. Furthermore, given the usual urgency of repair tasks such as the aforementioned, there is the compounding problem of locating a worker or group of workers having the required expertise that are within a serviceable distance from the fault location.

As another example of deployment of personnel, an organization may be required to send an ICT worker to a customer's premises to repair an item of computer networking hardware. The task requires a worker having a specific certification and within a distance allowing for the worker to travel to the customer premises and complete the task by the end of the business day. Each of the workers in the pool of workers having the required expertise is normally mobile, moving from customer to customer throughout the day.

A further example is in a sales environment whereby a first worker in a first geographical location may receive a sales lead from a potential customer in a second geographic location. The first worker wishes to place the potential customer in contact with a worker having the appropriate expertise in the second geographic location. In this example, each of the pool of workers having the required expertise is not mobile, but in fixed geographical locations in the organization's service region.

In some instances, the issue of geographical location is not relevant, with the problem being merely to identify personnel capable of addressing a customer need.

Similar problems can arise in intra-organizational settings, where two or more organizations cooperate to provide a product and/or service to a customer.

It is an aspect of an exemplary embodiment of the present invention to alleviate or overcome one or more problems of the prior art by providing means for individuals within an organization (or across organizations) to expand contact networks. From an organizational perspective, an embodiment of the invention seeks to identify personnel having a desired skill or holding information relevant to a problem or an enquiry, with the aim of facilitating the interchange of information and skills between personnel so as to foster cooperation, problem solving, innovation, or address customer needs.

It is a further aspect of an embodiment of the present invention to provide means for the selection and efficient deployment of appropriate mobile personnel to a geographical work location, or to selectively deploy non-mobile personnel dispersed across an organization's service area.

The discussion of documents, acts, materials, devices, articles and the like is included in this specification solely for the purpose of providing a context for one or more embodiments of the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, an embodiment of the present invention provides a system for identifying personnel within an organization, the personnel being identifiable by reference to a knowledge, skill, experience, or information held, the system being implemented on a computer network of the organization, the system comprising:
(A) a database configured to connect to the computer network, the database comprising
   (i) knowledge, skill, experience or information held by one or more personnel of the organization, and
   (ii) contact details of the one or more personnel; and
(B) one or more processor-enabled devices configured to connect to the computer network, the one or more processor-enabled devices configured to search the database,
   wherein the system is configured to allow one or more processor-enabled devices to interrogate the database for a desired knowledge, skill, experience or information held, and where the desired knowledge, skill, experience or information, is held by one of the one or more personnel the one or more devices provided with the identification and/or contact details of the personnel holding the desired knowledge, skill, experience or information.

In one embodiment of the first aspect, the network of the organization is a private network configured such that it is not accessible by a processor-enabled device that is not owned, operated, controlled or administered by the organization.

In one embodiment of the first aspect, the network of the organization is implemented completely within a firewall of the organization.

In one embodiment of the first aspect, the knowledge, skill, experience or information held by the one or more personnel of the organization is obtained by a method which is at least partially controlled by the organization.

In one embodiment of the first aspect, the method of obtaining the knowledge, skill, experience or information comprises presentation of the one or more personnel of the organization with a structured questionnaire.

In one embodiment of the first aspect, the structured questionnaire is presented to the one or more personnel of the organization at the commencement of employment and/or at regular intervals during employment.

In one embodiment of the first aspect, one or more question(s) of the set of predetermined questions is presented with a set of multiple choice answers.

In one embodiment of the first aspect, the system is configured such that the database is configured such that it is searchable for the knowledge, skill, or information held by the one or more personnel by keyword(s), or system-defined lexicological equivalent(s) thereof.

In one embodiment of the first aspect, the database is configured such that it is searchable for the knowledge, skill or information held by the one or more personnel by an explicit request for information, or in the form of a problem, a hypothetical scenario, or a case study.

In one embodiment of the first aspect, the database comprises the geographical location or geographical region of personnel so as to allow for personnel to be searched according to geographical location or geographical region.

In one embodiment of the first aspect, the system comprises a data feed providing substantially real time information on the geographical location of personnel so as to allow for personnel to be searched according to geographical location or geographical region.

In one embodiment of the first aspect, the system comprises one or more mobile devices in operable connection therewith, each of the one or more mobile devices being location-enabled such that each of the one or more mobile devices contributes to the data feed.

In one embodiment of the first aspect, the system is in operable connection with a logistics management system configured to manage the delivery of a product and/or a service to a site.

In one embodiment of the first aspect, the system is configured to select one or more mobile personnel to travel to at a site where a product and/or service is to be delivered, wherein the selection is based on a skill, knowledge, information or experience required for a task to be executed at the site and optionally geographical location of the personnel

In one embodiment of the first aspect, the system comprises a database configured to connect the computer network, the database comprising:
(i) task-related knowledge, skill, experience or information held by one or more personnel of the organization,
(ii) identification and/or contact details of the one or more personnel; and optionally
(iii) geographical location information of the one or more personnel,
   wherein the system is configured to allow for interrogation the database for one or more personnel having a desired task-related knowledge, skill, experience or information for a service required at a site, and where the desired task-related knowledge, skill, experience or information is held by one of the one or more personnel the system provides the identification and/or contact details of the personnel having the desired task-related knowledge, skill, experience or information.

In one embodiment of the first aspect, the system comprises one or more remote location-enabled devices configured to connect to the private computer network, the one or more remote location-enabled devices configured to be carried by the one or more personnel and to detect the geographic location of the one or more personnel, wherein the geographical location information of the one or more personnel of the database is obtained from the one of more location-enabled devices.

In one embodiment of the first aspect, the system comprises a computer-implemented personnel management or communication system that:
(i) is in operable communication with the system and/or the system database,
(ii) forms the database,
(iii) forms part of the database,
(iv) is an intranet, or
(v) is an email system

In one embodiment of the first aspect, the computer-implemented personnel management system is selected from a group consisting of a human resources system, a customer relationship management system, a personnel recruitment management system, a logistics management system, a workforce management system, an active directory system, a learning management system.

In a second aspect, an embodiment of the present invention provides a computer-implemented method for identifying one or more mobile personnel for deployment to a work site, the method comprising the steps of obtaining information on one or more personnel of the organization, the information relating to a task-related knowledge, skill or information held by the one or more personnel and a geographical location of the one or more personnel, entering the information into a database such that the identification and/or contact details of the one or more personnel is linked to the relevant personnel's information, and optionally interrogating the database for a desired task-related knowledge, skill or information, and where the desired task-related knowledge, skill or information is held by one of the one or more personnel the identification and/or contact details of the personnel having the desired task-related knowledge, skill or information is displayed or passed on for dispatch.

In a third aspect, an embodiment of the present invention provides a computer-implemented method for sharing information held by personnel within an organization, the method comprising the steps of obtaining information on one or more personnel of the organization, the information relating to a knowledge, skill, experience or information held by the one or more personnel, entering the information into a database such that the identification and/or contact details of the one or more personnel is linked to the relevant personnel's information, and optionally interrogating the database for a desired knowledge, skill, experience or information, and where the desired knowledge, skill, experience or information is held by one of the one or more personnel the identification and/or contact details of the personnel holding the desired knowledge, skill, experience or information is displayed.

### BRIEF DESCRIPTION OF THE DRAWING

FIG. 1 shows a block diagram showing an embodiment of the invention. The arrows designate the flow of information

FIG. 2A is a block diagram showing a preferred embodiment including an active directory system from which a personnel search system derives contact information of personnel via an API. The arrows designate the flow of information.

FIG. 2B is a block diagram showing a preferred embodiment including a workforce management system (WFM) from which a personnel search system derives availability information of personnel via an API. The arrows designate the flow of information

FIG. 3 is a block diagram showing a preferred embodiment having a personnel search system, a workforce management system and a logistics management system. The personnel search system can obtain personnel information from the logistics management system and the workforce management system. Moreover, the latter two systems are in operable connection with a mobile service agent having GPS equipment to provide location information which can ultimately be routed to the personnel search system. The arrows designate the flow of information.

FIG. 4 is a block diagram showing a preferred embodiment whereby the present system is in operable communication with a logistics software platform operated by a company that is separate to that operating the present system. The arrows designate the flow of information.

FIG. 5 is a diagram showing further detail of the flow of information and manipulation of information in the embodiment of FIG. 4.

FIG. 6 is a diagram showing further detail of the flow of information and manipulation of information in the embodiment of FIG. 4.

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

Applicant proposes that one or more problems of the prior art may be overcome or at least alleviated by providing means for personnel within an organization to exploit knowledge held by others within the same organization. Accordingly, in a first aspect, an embodiment of the present invention provides a system for sharing information held by personnel within an organization, the system being implemented on a private computer network of the organization, the system comprising: (A) a database configured to connect to the private computer network, the database comprising (i) information held by one or more personnel of the organization, and (ii) contact details of the one or more personnel; and (B) one or more remote processor-enabled devices configured to connect to the private computer network, the one or more remote processor-enabled devices configured to search the database, wherein the system is configured to allow a user of the one or more remote processor-enabled devices to interrogate the database for a desired information, and where the desired information is held by one of the one or more personnel the user of the one-or more remote devices is/are presented with name and/or contact details of the personnel holding the desired information.

An exemplary embodiment of the present invention is a significant advance on prior art methods of personnel interaction within organizations. Applicant proposes that the present systems may unlock the significant reservoirs of skills, knowledge, experience and information held by personnel for the exploitation of others in the same organization (or in some embodiments, in another organization), with a view to advancing the organization (or the other organization, or the combination or organizations) in some commercial aspect. This sharing of skills, knowledge, experience and information may be achieved in a secure manner within the organization, or between two cooperating organizations via a private network. Furthermore, the skills, knowledge, experience and information may be procured and disseminated in a controlled manner with the system providing the organization(s) with administrative controls.

The skills, knowledge and experience will typically be useful to the operations of the organization(s), and may be of a practical nature, and moreover may be related to a product or service provided by the organization(s) to a customer. In this sense, a qualification or a certification relating to the delivery, installation, operation or training of a product of the organization(s) is contemplated. Thus, appropriate personnel may be selected to the deliver, install, operate or train in the use of a product for the benefit of a customer. For example, the personnel may be selected on the basis of holding a heavy vehicle license, or have a manual trade or have a software certification to enable the customer's product and/or service needs to be satisfied.

In one embodiment, the information held by personnel and subject of the system does not include simple data. For example, company-administered data that is searchable and/or accessible to some or all personnel (or at least a subset of personnel) is not included in some embodiments. Examples of company-administered data include sales data, Gantt charts, production schedules, marketing materials, and the like.

In one embodiment, the information is information that is not normally available to all personnel of the organization, or at least not normally available to a subset of personnel. While project teams within an organization may be availed of computer-based means to search for information held by team members, this information may only be available to team members. The information may well be potentially useful by personnel outside the project team but is not searchable or available to members of other project teams. Similarly, the information may only be normally available to personnel on a particular floor within an office, at a particular geographical location, or at a certain level of seniority. In some embodiments, the present invention overcomes these barriers to allow for the sharing of information across an organization.

In one embodiment, the information relates to matters that the organization would prefer to keep confidential, or must keep confidential. For example, where the organization is a pharmaceutical company it may be deleterious (legally or commercially) for the company to allow personnel to exchange information on production issues, or negative clinical trial results in an unsecure manner.

The information may extend to matters such as particular work-related problems or issues that personnel are facing or have faced, or particular work-related interests of the individual. The personnel information may relate to any of knowledge, skill, experience, current and past work-related problems, current and past work-related issues, current and past work-related ideas. The personnel information may relate to previous organizations, current role, responsibilities, group level, work-related interests, work-related likes, work-related dislikes, and language fluency.

As used herein, the term “private network” is intended to mean a computer network that is configured to decline access to individuals outside the organization. In one embodiment, the network is not accessible to the internet except by way of password, biometric contrivance, or other security mechanism. In one embodiment of the system the private network of the organization is configured such that it is not accessible by a processor-enabled device that is not owned, operated, controlled or administered by the organization. In one embodiment, the private network of the organization is implemented completely within a firewall of the organization.

As used herein, the term “personnel” is intended to be construed broadly to include one or more of the following: one or more full-time employees, part-time employees, contractors, consultants, and volunteers. The term may be used in the singular, or the plural as required by the context.

As used herein, the term “organization” is intended to be construed broadly to mean any collection or individuals in the pursuit of one or more common goals. The organization may be for profit or not-for-profit, privately owned, publicly owned, or a government organization. Preferably, the organization is a commercial organization for profit. Given the problem of silos in larger commercial organizations, an embodiment of the invention is particularly applicable to organizations having at least about 100, 200, 300, 400, 500, 600, 700, 800, 900, 1000, 2000, 3000, 4000, 5000, 6000, 7000, 8000, 9000, 10000, 15000, 20000, 25000, 30000, 35000, 40000, 45000, 50000, 60000, 70000, 80000, 90000, 100000, 110000, 120000, 130000, 140000, 150000, 160000, 170000, 180000, 190000 and 200000 personnel. Preferably, the organization has at least about 50000, more preferably more than about 100000 personnel. Greater advantages are proposed for very large organizations given the very significant problems of silos in such establishments. It is considered that for very large organizations the problems of silos are virtually insurmountable by those inside and outside the organizations, and so use of an embodiment of the present invention can provide unexpected advantages.

In some embodiments, the organization has less than about 5000000, 4000000, 3000000, 2000000 or 1000000 personnel.

A significant advantage of the present systems results from the structured nature of the information held by the database. Prior art facilities which are based on social networking platforms allow users to freely enter information, but they are just as free to not enter information that may be important to the organization. Accordingly, any database incorporated into prior art facilities will be incomplete and/or difficult to search.

The structured nature of the information of the present systems may arise from the information being obtained from personnel by a method which is at least partially controlled by the organization. Intervention by the organization is proposed to increase the completeness and/or reliability of the information held in the database. This approach is in direct contrast to prior art facilities which allow personnel to control what type of information to enter, as well as the quality of information that is entered.

The method of obtaining information may comprise presentation of the one or more personnel of the organization with a structured questionnaire. The questionnaire may be administered to the one or more personnel in any convenient format. In one embodiment the structure questionnaire is presented to personnel in the course of an interview, for example during an induction process. A member of the human resources department may pose a series of predetermined questions in order to increase the likelihood of eliciting information which may be of use to the organization.

More typically, the structured questionnaire is presented to personnel in the context of a web browser, or similar format. Entry of information can be elicited in a highly structured manner, with the answer to a question directing subsequent line(s) of questioning. As an example, a first question may relate to the skills in which a marketing professional has practical expertise: internet; television, print media, or radio. Where the answer is “internet” a specific group of sub-questions will be posed, requesting whether the internet marketing expertise is in the field of web page design, content, analytics, running alternative campaigns etc. Such sub-questions will be irrelevant to a marketer having experience only in print media, for example. It is proposed that this method of guided questioning can result in superior quality of information given that personnel can more fully respond to only more relevant questions.

The method of obtaining information from the one or more personnel of the organization may be computer-implemented, and optionally incorporated into the present systems.

In one embodiment, the structured questionnaire is presented to the one or more personnel of the organization at the commencement of employment and/or at regular intervals during employment. The system may comprise means for automatically forwarding reminder correspondence to personnel (such as by email, SMS text message, or app notification) in a periodic manner, prompting personnel to update information.

The nature of the predetermined questions may, to some extent, rely on the particular type of organization. For example, where the organization is an information technology organization the predetermined questions may relate predominantly to the types of operating systems, computer languages, wireless data transfer protocols, or database architectures in which the personnel has detailed knowledge.

As another example, where the organization is a recruitment organization the predetermined questions may relate predominantly to identifying and capturing existing or ongoing client relationships which may be exploitable by the organization, any industry sub-sectors in which the personnel is particularly familiar, or experience in organizing displays at employment fairs.

It will be appreciated that the examples provided herein may be trivial in nature, however the skilled artisan is amply enabled to decide on a predetermined set of questions useful for the industry sector of a particular organization.

In one embodiment, the one or more question(s) of the set of predetermined questions is presented with a set of multiple choice answers. It is proposed that significant advantage is obtained given that highly structured (and therefore easily searchable) information is generated where personnel have only a limited number of options from which to select in answering a predetermined question.

As an example, where the organization is a professional legal services organization a predetermined question may relate to litigation experience, and more particularly the litigation areas in which the personnel has experience. The multiple choice answers to that question could be selected from the following:
Litigation strategy
Pre-trial discovery
Pre-trail mediation
Briefing expert witnesses
Briefing counsel
Drafting claims and counterclaims
Damages assessment
Media relations during trial

The multiple choice answers may be provided, by way of selection on a printed page, by drop-down menu or radio buttons on a browser page, or verbally during interview.

It will be understood that while some embodiments of the present systems comprise structured methods of eliciting information from personnel, unstructured means (such as inviting the user to enter “free-text”) are not precluded. Indeed, some predetermined question may not be amenable to structures means.

Preferably, the information obtained and retained by the present systems is not predominantly social-related information. In one embodiment, the information is less than about 50%, 45%, 40%, 35%, 30%, 25%, 20%, 15%, 10% or 5% social-related information. As used herein, the term “social-related information” is intended to mean information that does not apply to work. Social-related information broadly includes information relating to hobbies, interests, personal relationships, sports, family life, entertainment, and the like. It will be understood that the definition of social-related information may vary according to the industry in which the organization is involved. For example, while information relating to clothing fashions would constitute social related information where the organization is an engineering company this would not be the case where the organization is a fashion magazine.

The present systems are configured to allow a user of the one or more remote processor-enabled devices to interrogate the database for a desired information. By this configuration, a user is enabled to search (and particularly by a faceted search) for knowledge, skills or experience held by personnel of the organization with the aim of dealing with a business problem, or other matter such as identification of personnel having the skills required to fill another position within the organization. As mentioned supra, the use of predetermined questions (and optionally in multiple choice format) aids in the generation of a rigorously searchable database. Alternatively, the database may be searched by personnel name in order for management (and possibly others in the organization) to review the skills, experience and knowledge held by a particular individual.

The database may be searchable keywords (and system-defined lexicological equivalents thereof) and/or attributes of a record; by knowledge, skills, experience, past employers, geography, or even business-related issues and ideas posted by personnel for general viewing across the organization. The database may be searchable to identify cohorts having shared attributes or keywords.

As will be apparent from disclosure elsewhere herein, a system-defined lexicon comprising one or more linguistic equivalents to a keyword may be used to form the basis of a search.

In one embodiment, the system is configured such that when searching the user is presented with a descending numerical counter which is automatically activated as inclusion of keywords (or system-defined lexicological equivalents) gradually tightens and pinpoints the search. There may be a rewarding outcome of this embodiment which encourages the user to be more focused in their use of keywords. Adding relevant keywords terms gives the searcher the satisfaction of seeing his or her search narrowing toward the personnel sought.

The counting down may be embodied in the form of a digital disk or other visual counter, the results of a search. For instance, the total number of possible people within any system database is made visible on the user interface. As the user adds to and refines their search criteria, the number of matches is instantly made visible to them. As one example, where the database holds 50,000 searchable people in its private network, as each search term is entered it shows, say, 360 matches, or 250 matches or 49 hits or 7 matches or no matches.

The provision of a counter encourages the user to continue to tighten and refine their search terms until a point is reached where they feel there are sufficient people who meet their criteria. At this point the user can examine the profile(s) held in the present system and contact the identified personnel via the contact details, or automatically via Chat, Slack, email etc. In this Embodiment, where there are no or insufficient matches to a user's search criteria, the user may be motivated to try other search terms in order to identify a match.

In one embodiment of the systems, the search terms are selectable by drop down menus or radio buttons. Typically, the selections of the menus or buttons are the same as those used when information was entered into the database. The consistency in usage of terms may lead to increasing the chance of identifying individuals having a given attribute. In prior art facilities using free-text as basis for entry and searching of databases it is proposed that a significant number of “matches” will be missed. For example, US-based personnel within a paper products organization may enter in the system expertise in the field of “diaper manufacture”, while an Australian user may search the database for expertise in “nappy manufacture”. The Australian user will not be provided with contact details for the US-based personnel because of the disparity in terms used for infant absorbent products.

In some embodiments, the present system may comprise a lexicon configured to provide a more sophisticated, versatile or useful search functions available to the user. Typically, the lexicon will be inherent in system software, or stored on a system database for retrieval by system software. The lexicon may comprise standard terminology for naming things (proper nouns), abbreviations for those things, acronyms, synonyms and alternative spellings. The lexicon may also comprise verbs relating to services provided.

The present system may be configured by software means to provide a search engine capable of finding terms that are the ‘same as’ and those that are ‘similar to’ or that are ‘related to’ a lexicon entry or user query. The rules determining these relationships are encoded in system software by algorithmic means.

In one embodiment, the present system comprises (in algorithmic form) a synonym matching facility. For instance, a user who is searching for an individual with a Bachelor of Arts degree will find such an individual whether they enter B.A degree, B.A. degree, B.A. degree, Arts Bachelor degree, BA, B.A. or B.A (this list not being definitive, and only exemplary).

Search terms of the lexicon may be augmented by additions entered by a system administrator or because a user has previously searched by a term that the present system identified as not being in the lexicon.

The lexicon administrator (or other appropriately trained and authorized individual) is enabled by way of user interface to insert new words or terminologies, acronyms, synonyms and so on, to the lexicon, or approve or not approve words or terms that the system has identified as not being currently in the lexicon but which users have entered as queries.

As a result of the lexicon, an individual using the present system's search function is offered drop down lists automatically generated from the lexicon as the user keys in the letters for the terms he/she wishes to search by. This invites the user to select from the drop down list, making for faster search response times.

The lexicon may comprise generic terms that are shared by all users in an organisation or network. In embodiments of the present system configured as a centrally hosted subscription arrangement (“software as a service”), lexicon terms may be shared by all users of the system in a cross-organizational manner. A set of lexicon entries may pre-exist in the present system, with further entries allowed to be added by a user or administrator over time and in accordance with terminology typically used in the organization. Such entries may relate to topics such as language, cities, countries, universities, qualifications, certifications, etc.

As will be appreciated, lexicon entries may be related to a particular type or category of function, business, or organisation. These entries can be searched by any user in a particular organisation or network that uses the present system. Exemplary categories include telecommunications, the military, health, cancer research, financial services, information technology and the like. Such entries are more specific in nature, however the same considerations for lexicon building using the generic terms apply to more specific entries. Thus, some entries relating to a particular function may pre-exist in the system and are therefore immediately usable. Further entries may be amended by authorised individuals within the organisation which implements the present system.

Lexicon entries of the system may be highly specific to a particular organisation and reflect internal usage. Such terms may have little meaning or a different meaning to persons outside the organization. Such highly specific terms may include acronyms and other terms routinely used in the organisation in a manner akin to a secret or tribal dialect. The organization-specific entries may include internal project titles, customer names and nicknames. In the case of Logistics Management Systems these terms could reflect specific products or services. These lexicon entries may be treated by the system as private (secure) to the organisation or network and can only be viewed, added to or amended within the organisation and by individuals in the organisation authorized to do so.

In some embodiments, the present system is configured to provide electronic or hard copy lists and reports on terms users request in their search criteria that do not already reside in the lexicon. These can be viewed online or can be printed out. These new terms or search requests can be added to, amended or deleted by people authorized to do so via the present system.

Any rules that apply to building the lexicon are provided to authorized individuals. The rules and help associated with adding to and amending the lexicon are provided as online help and/or in training manuals, and/or in training sessions provided by the organization implementing the present system.

The options for making additions and amendments to the system lexicon may be prescribed by the taxonomy and optionally tightly controlled by the software. However, the present system is preferably configured to make the process relatively easy from a user standpoint and circumscribes choice as far as possible.

From time to time, authorized individuals may be enabled by the system to integrity check the lexicon which is configured to highlight or reject entries that it identifies as entries that require further enquiry or checking. This may occur if, for instance, there is no evident relationship in terms of spelling with the addition of a term to a particular location in the lexicon. There may be good reason (for example, the entry may be a synonym), but the individual checking the lexicon may be asked to confirm they wish to insert the entry in the intended lexicon location, by way of user interface: “Are you sure this term belongs here? Yes/No?”.

Some embodiments of the present system comprise means configured to secure access to the system, the ability to make entries into the system, the ability enter queries or requests to the system, the ability to enter or alter or delete system information, the ability enter, alter or delete system lexicon entry, and the like. Typically, such means will be configured in software of the system. A permission, validation or authorization of a user or other individual may be provided upon entry of appropriate credentials (such as username and password) into a user interface of the system.

The present system may have built in permissions rules which relate to one or more number of system functions and can be added to or disconnected. For instance, an organisation or membership may require a line manager to validate user-entered data in a HR function before it is released/published online to others in the organization.

In this way, the level of extraneous material and misinformation entered by users pertaining to themselves is minimized. Thus, a user entering information about himself/herself is generally prohibited from introducing false information or omit relevant information given the oversight by a line manager who will be well placed to identify any such deficiencies in the user-input information.

In some embodiments, the system is configured to operably connect to other electronic sources of personnel-related information that are trusted, pre-validated or otherwise considered reliable. For instance, information on training or certifications may be uploaded into the present system from an organisation's Learning Management System. Performance data can be uploaded from the Performance Management System. Titles are automatically drawn from the corporate or member directory, and so on.

While approving personnel-related data is time-consuming and may be avoided by the relevant person required to authorize it before being published online, personnel/users/members are less likely to lie or slant data about themselves in a closed (private) network where it is likely that an untruth may be uncovered.

The present system may be configured to provide a permissions function to ensure that only personnel nominated and authorized for particular system functions can perform those functions. For instance, only certain senior executives or HR professionals may be able to view certain types of data on personnel; only authorized individuals may have permission to use the organisation-wide personnel information.

The present system may be configured to allow an authorized individual to search a personnel database and identify groups of individuals, and optionally create and view shortlists of individuals capable of fulfilling a particular customer need or a need of the organization. Identify of such groups may be used by an organization's management to redeploy and deploy human resources as required, mobilise relevantly talented individuals, optimise workforce, assist in succession planning, assess group capabilities, manage performance, disrupt distribution lists, analyse and report on the employee base.

This embodiment is similar to the basic system function capability disclosed elsewhere for identifying a single individual but with an additional set of search criteria that pertain to any use listed in the immediate previous paragraph.

The faceting and weighting of the search may be adapted to relevant requirements and so from the user perspective they may be invited by the system to search in a different way. For instance, a user may want to identify talent in a particular location with particular attributes in terms of knowledge, experience and skills. Or a user may want to add hierarchical levels to this search so may, for instance, add ‘Group 3’ to their search, or the title Manager.

The results of the search may be exported by the system as a list, as a csv file, or as a printed or online report.

The present system may, in some embodiments, provide advantage over prior art distribution lists. By the present system, a user is enabled to instantly generate an up-to-date list of personnel matched to need and searched by the present system from its database and use this list for reasons such as identifying and redeploying personnel for particular projects, viewing talent or succession candidates, and optimising the workforce by understanding which individual(s) are in possession of defined information, and furthermore where such individuals are located.

Redeployment and mobility of an existing workforce is generally preferred to an external search to find personnel matching a particular need in an organization on the basis of cost-effectiveness and efficiency. An embodiment of the present invention provides a new tool for investigating opportunities for redeployment of staff whose position within an organization has been made redundant.

The present system may in some embodiments provide advantage in analysis and reporting to management of an organization by way of an integral report generator. Such reports may provide HR professionals, executives and managers in an organization with a rich dynamic view of human capital available, their skill levels, availability and so on.

It is contemplated that the present systems may be useful in referring business opportunities to one or more personnel in an organization. For example, a sales enquiry may be received by an initial contact person not in the relevant business unit of the organization. That person may utilize the present systems to identify personnel able to assist the enquirer. The search may identify a number of relevant personnel, each of whom would be desirous of assisting with a view to securing a sale from the enquirer.

The system may be configured to allow the initial contact person to dispatch emails, SMS text message, or app notification to each person identified as potentially relevant to the enquiry. In one embodiment, the first person to respond is rewarded with the contact details of the enquirer while others are disqualified at first instance.

Preferably, the system is configured so as to not require the intervention or involvement of an initial contact person. In that circumstance, the system is configured so as to automatically identify and alert the person most relevant to respond to an enquiry in a “frictionless” manner.

The present systems may be configured to utilize the position descriptions of all personnel as a source of information relating to the experience and knowledge of personnel. In some embodiments, the position description information is the primary source of information (or at least a highly weighted source of information), which may be supplemented by other information sources such as that inputted by individuals. It is proposed that position description information may be a more reliable indicator of experience and knowledge held by an individual, as compared with other sources.

The present systems may be configured to search current and previous positions held by the member of an organisation by reference to position description, rather than a title. This provides an organisation with the ability to track the evolution of a member's skills, experience and knowledge over time and hence make a more accurate assessment of the value of a member against current business requirements.

Furthermore, when an individual assumes a new position within an organization, the position description attached to that individual in a human resources database will change upon their commencement in the new position. This approach ensures that information searchable for an individual is current, and lessens the chance that a search identifies individuals based on outdated information.

Some embodiments of the system are configured to provide real-time (or near real-time) reporting on the activity of new and established connections between individuals within an organisation in response to changes in organisational strategy. This reporting (typically viewed by senior management of the organization) provides longitudinal insight into the effectiveness of internal marketing and communication, as well as into who the influencers are for a given strategic shift.

An embodiment of the present invention has utility in the selection of personnel having a required task-related expertise, and also the deployment of such personnel at various geographical locations within an organization's service area. A task-related expertise may be any expertise related to the goal of assisting a customer's need, or a need of the organization in which the personnel is/are employed. The expertise may be a manual expertise such as a trade or a technical expertise, or a non-manual expertise such as a sales expertise or a customer service expertise. The various geographic locations may in some embodiments relate to a changing geographic location (for example, a mobile computer technician) or a group of various fixed geographical locations (for example, a number of bank investment advisers with each advisor working at a different bank branch).

In any event, this alternative embodiment of the system functions so as to allow an organization to provide one or more workers at a worksite, each of the workers having an expertise required to carry out one or more tasks. In this way, a customer (including an organizational internal customer) that has a task-related need is provided with the personnel to fulfil that need. The task-related expertise of the personnel of an organization may be obtained and refined according to any means discussed elsewhere herein in relation to information held by personnel. Thus, an expertise may be accorded against a particular worker by way of face-to-face interview, computer-based questionnaire and other such means as disclosed herein or as will be apparent to a person having ordinary skill in the art having the benefit of the present specification. In any event, the expertise is linked by the system database to the individual worker having the expertise. Thus, when searching for certain task-related expertise the system provides the user with the name, identifier or contact detail of a worker having that expertise.

The provision of geographical location by way of the system database further assists in the delivery of a service to a customer. Where a worker's geographical location is fixed, the location is recorded as a database entry that remains unchanged, at least until the worker changes location. Where a worker is mobile, the location may change a number times throughout the day, or week or month. The worker's location may be updated by reference to a third party personnel management system that tracks a worker's location (by GPS means, for example).

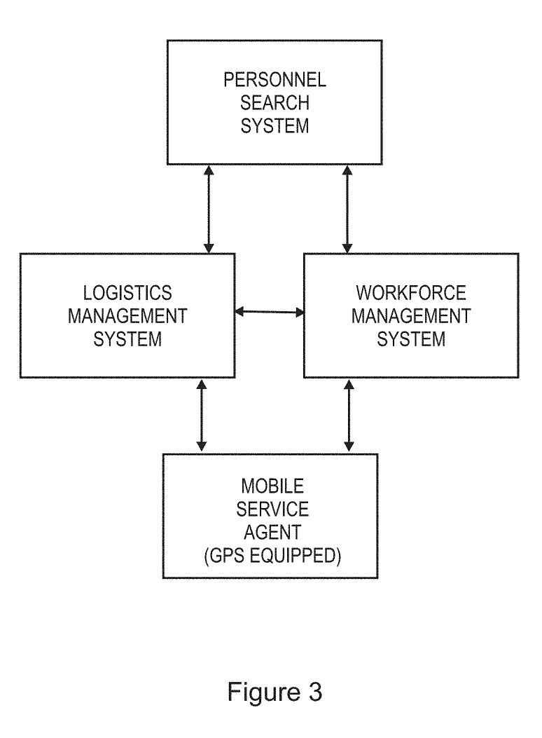

The availability of a worker may be added to search criteria in the system taxonomy. The addition of availability to location data may determine which worker receives the top weighting (by system algorithmic means) in terms of being allocated to provide a mobile onsite service to a customer. Data from Logistics Management Systems that apply GPS positioning to each service provider is relevant to a search executed by the present system in such scenarios. Such an embodiment is shown at FIG. 3, and further including a Workforce Management System as a further source of information used by the basic personnel search system.

Such applications can be extrapolated, for instance, to military use where in addition to identifying suitable person(s) for a task (ordered and weighted by the present system taxonomy and search criteria), they can be further identified against the requirement for a location at an acceptable distance to the work site. As one example, a military unit may have a requirement for a drone pilot who speaks Farsi, is certified to fly the DJI Phantom 3 drone, and is within two hours of Fort Worth, USA.

The database of the present system need not be a single database. Instead, the present system database may in fact comprise of multiple databases. For example, a human resource system database may comprise personnel name, contact details and task-related expertise, while a technician dispatch system database comprises personnel name and location. Both databases have a common field (personnel name) and the system database (having personnel name linked to personnel contact details, linked to personnel expertise, linked to personnel location) has information distributed across two databases. In some embodiments, there is only a single database, which may be essentially a portion of a human resources database. In this embodiment, the personnel may have a fixed geographical location it being typical for a human resource database to comprise information on a worker's usual office or depot location.

As will be apparent from the disclosure above, in some embodiments of the present system a database of a third party system is a component thereof. Alternatively, the system database may be a dedicated single database that obtains required database entries from third party personnel management system databases.

Where the present system comprises a third party system, that system may be embodied in software and/or hardware. Systems comprising a third party system may be configured accorded to embodiments which search for personnel having a required information, skill, knowledge, experience, task expertise or location.

The third party system may comprise dedicated software and/or dedicated hardware according to its function within the overall functioning of the organization. Embodiments where the third party system is a human resources system are disclosed above. In those instances, the human resources system may be a relatively simple standalone system (such as Workday™, Ultipro™, Ceridian™ or ADP™). For larger organizations, the human resources system will typically be module of an larger system, such as an n Enterprise Resource Planning System (ERP). An exemplary form of such an arrangement is the Core HR™ module of SAP™. Other examples of human resource systems include PeopleSoft™, Workday™ and Oracle™.

As a further alternative, the system database may be fed information in real time from a server. As one example, an organization may track service vehicles by GPS means, with GPS information passing through a server in operable communication with a server of the present system.

The third party system may be a Customer Relationship Management system (such as Salesforce™ and Siebel), or a recruitment management system (such as iCIMS Recruit™ and Taleo), a logistics management system (such as SAP Logistics Network Solutions™, Oracle Logistics Management, GetSwift, ePRomise, LogiNextmile, LockandLocate, TMW systems), a workforce management system (such as Kronos Workforce Central™, Deputy, When I Work, uTRAC, GSMtasks), an active directory system such as Microsoft Active Directory™), a performance management system (such as Trakstar™ and Cornerstone™), a learning management system (such as Docebo LMS™ and Adobe Captivate Prime™), or a collaboration system such as Sitrion™, Yammer™, Slack™ and Jive™).

Third party system software may be integrated into the present system using routine means well known to the skilled person. Alternatively, the present system may be integrated into the third party system. Such integration may be a full integration whereby the present system is integrated in the third party software stack. As a further alternatively, the present system and third party system may remain essentially discrete with information interchange (simplex or duplex) being provided by way of application programming interface (API).

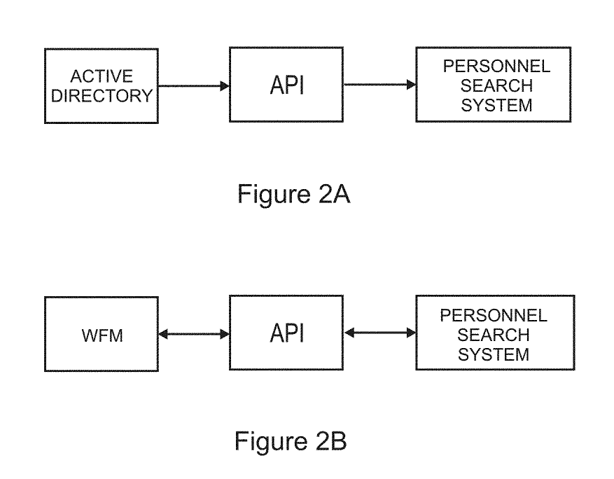

The present system may be configured to import relevant data from third party software (for example, by way of API) and automatically (for example, by way of algorithmic means of the system) incorporate the relevant logically into a search for one or more personnel. As one example, an enterprise directory system such as Microsoft Active Directory™ provides means for the present system to obtain up to date name and contact details about personnel of an organisation, a private network, or a customer network. Such directory systems customarily record and maintain current master information about personnel and other individuals and entities including, for instance, name, title, address, contact details including email, mobile number, phone number. The present system is configured in some embodiments to obtain information from such a directory source. Typically, this is one-way data import whereby the present system does not send data back to directory systems. Reference is made to FIG. 2A which shows the extraction of active directory information via an API into the present system.

An advantage of embodiments having access to an active directory is that personnel stored and searched by way of the present system are always current. Personnel that have departed the organization are not included in the search and match process. When there are redeployments and restructuring of organization the alterations are typically reflected in corporate directories and therefore automatically flow through to the present system. In some the present system stores active directory data for a predetermined period before refreshing, and in other forms the directory data is updated in substantially real time.

Authorised individuals of an organization can print out lists of personnel identified via the present systems search functionality, and export these lists (for example in the well known csv format) together with contact details, to third party software such as collaboration software (Sitrion™, Yammer™, Slack™, Jive™ and the like), an organization intranet, SMS text message, app notification, or an email system.

Prior art collaboration software systems are generally poor at identifying personnel against search criteria. The systems typically use an organization's directory system allowing for a user to search for an individual by name (assuming the user correctly spells the name), or by job title (assuming the user knows the exact title) and other ‘blunt’ criteria. Prior art collaboration systems' ability to apply an intelligent search to their personnel database is generally unsophisticated; this being reflected in search results which can be unhelpful to a user in so far as an individual or group of individuals having the required characteristics is not identified.

An embodiment of the present invention provides additional depth to the functionality of collaboration software and may be either integrated fully or can hand-off search data automatically in response to the need generated in the third party collaboration software. The functionality of the two systems may be functionally seamless such that it is not apparent to the user that the present system is in operation.

With regard to integration with Human Capital Management (or Human Resource Management) software such as ERP systems SAP™, PeopleSoft™, Oracle™ and so on can provide rich information to add to the present system's search functions. For example, the information may be current training and certification data (Learning Management System functionality) or Performance Management data.

With regard to integration with recruitment management systems (Taleo™, Bullhorn™, and the like), information on unsuccessful shortlisted candidates may be accessed and as such provide a first line resource on subsequent searches for talent. In this case the effort already expended in finding and vetting potential shortlisted candidates is maximised.

With regard to integration with workforce management software, the present systems may be used to identify the best skilled personnel in its database and pass that information to workforce management software. The workforce management software has the ability to identify (amongst the shortlist of appropriately skilled personnel) to identify those (if any) currently available or available according to a particular schedule.

By providing the present system with additional information pertaining to individual's work availability according to a prescribed timeframe (for example, now, in one hour, in 24 hours, next week, on Monday 25th April, a.m. or p.m. etc), distance from the work site, limitations of a service provision agreement or service level agreements or organizational policy, then they are passed over by the present system.

If an individual is available within this location radius and timeframe then this satisfies the first filter applied to the present system search parameters. If an individual is available within a prescribed timeframe and in a suitable location the present system continues with its weighted, faceted search based on a prescribed taxonomy to find the best individual (with regard to a skill, knowledge, experience or task-related expertise) in its database to provide a required service. The system may then automatically deliver the search results to the workforce management software for display to user.

The third party system may be configured to form a part of the present system to the extent that it contributes to the task of identifying one or more personnel having required task-related expertise, a skills and/or information, and/or knowledge and/or experience so as to identify personnel capable of servicing a customer (optionally at a required geographic location). In that regard, the third party system may be exploited for its ability to store or mine personnel information, personnel location or personnel task-related expertise.

As required by the present system, the user of the one-or more processor-enabled remote devices is/are presented with the name and/or contact details of the personnel holding the desired information or task-related expertise. The term “processor” refers to any device or portion of a device that processes electronic data, e.g., from registers and/or memory to transform that electronic data into other electronic data that, e.g., may be stored in registers and/or memory.

A requirement of a remote device is the ability to convey the desired information in a user-comprehensible form. While the device may convey the name and/or contact details of the relevant personnel by video, audio, graphical or paper means, more conveniently the information is provided as text on the screen of the device. To that end, the remote device may be a personal computer, a smart phone, a tablet, a net book, a note book, or a lap top.

The database of the present systems may be of any type capable of performing the functions described herein. Generally, the database is of the relational type, such as Advantage Database Server, Altibase, Apache Derby, Cubrid, Datacom, DB2, Drizzle, Empress Embedded Database, FileMaker, Firebird, HSQLDB, H2, Informix Dynamic Server, Ingres, InterBase, LucidDB, MAriaDB, MaxDB, Microsoft Access, FoxPro, Microsoft SQL Server, MonetDB/SQL, mSQL, Nexusdb, Omnis Studio, OpenLink Virtuoso, Oracle, Oracle, Rdb, Paradox, Peoplesoft, Pervasive PSQL, Polyhedra DBMS, Postgre SQL, RDM embedded, RDM server, SAP, ScimoreDB, smallSQL, SQL Anywhere, SQL Base, SQLite, Unidata and Xeround Cloud Database.

In a preferred form of the system, the database is based on data or a physical database that is ordinarily in place in the organization. Human resources departments typically obtain and retain personnel data such as name, address, date of birth, current office location, current position description, email address and the like. The present systems add an overlay of information in the form of personnel skills, knowledge and experience to the basic human resources data normally held by an organization. Larger organizations typically utilize Oracle, SAP or Microsoft SQL PeopleSoft and therefore the present systems are preferably configured so as to incorporate into these database types.

Any database of one or more embodiments of the invention may be embodied in the form of cloud storage (which may be hosted by a third party, albeit with a security layer to ensure privacy). Certain system components, most, or substantially all of the components including servers, software, processors and the like may be cloud-based. For example, the system may be configured at least in part in a “software as a service” format.

Conveniently, although not exclusively, the front end interface of the system is implemented in the form of a web browser or similar contrivance. Such embodiments are preferred given the familiarity of browser interfaces to many individuals. Although browsers are primarily intended to use the World Wide Web, they can also be used to access information provided by web servers in private networks or files in file systems. The major web browsers are familiar to the skilled artisan, including Firefox, Chrome, Internet Explorer, Opera, and Safari.

The private network of the present systems may be implemented by wired means, such as twisted pair wire, computer networking cabling (wired Ethernet as defined by IEEE 802.3), coaxial cable, ITU-T G.hn technology, optical fiber. The term “wired” and its derivatives may be used to describe circuits, devices, systems, methods, techniques, communications channels, etc., that may communicate data through the use of modulated electromagnetic radiation through a solid medium.

In addition or alternatively the network may be implemented by wireless means including terrestrial microwave, communications satellite, cellular and PCS systems, radio and spread spectrum technologies such the IEEE 802.11 protocols. In the context of this document, the term “wireless” and its derivatives may be used to describe circuits, devices, systems, methods, techniques, communications channels, etc., that may communicate data through the use of modulated electromagnetic radiation through a non-solid medium.

The network may implement any suitable communications protocol including an ethernet protocol, TCP/IP (including IPv4 and IPv6), Synchronous Optical Networking (SONET) and Synchronous Digital Hierarchy (SDH).

The network may be implemented at any desired scale including personal area network, local area network, storage area network, campus area network, backbone network, metropolitan area network, wide area network, enterprise private network, virtual private network, virtual network, or internetwork. A preferred embodiment is that of the enterprise private network given the enhanced security available.

As mentioned supra, a preferred embodiment of the system is implemented partially or completely within a firewall of the organization. The firewall may be either software-based or hardware-based (or a combination). The firewall may operate by network layer or packet filter, application layer, proxy, or network address translation.

In another aspect an embodiment of the present invention provides a computer readable medium comprising information as described herein, linked to the name and/or contact details of the personnel. The medium may be in the form of random access memory, magnetic hard drive, optical medium, or SSID for example. Preferably, the computer readable medium is managed as a relational database.

One embodiment of the systems and methods described herein is in the form of a computer-readable carrier medium carrying a set of instructions, e.g., a computer program for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method as described herein. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The information may be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers). The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

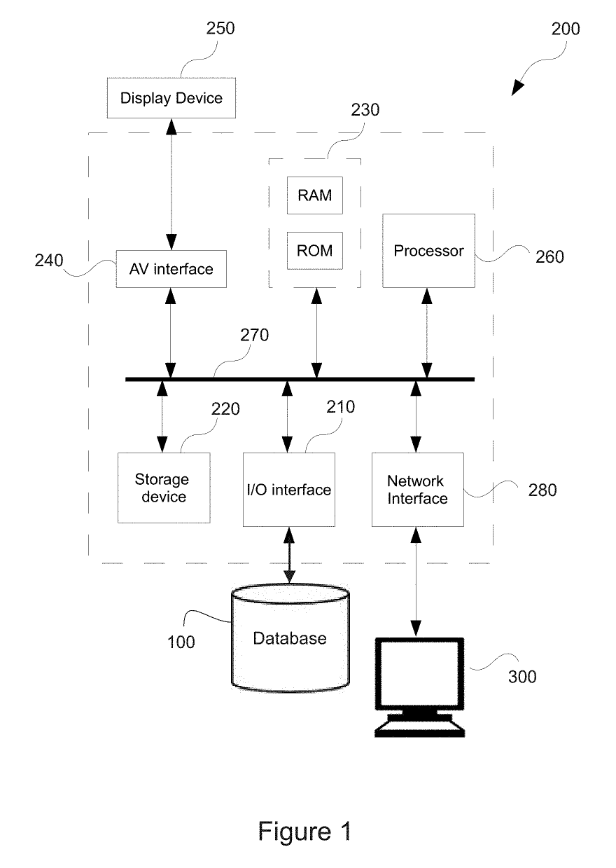

Reference is now made to FIG. 1 which a block diagram showing a preferred embodiment of the system is comprising a central database 100 having a plurality of records, each record having information on knowledge, skills and expertise held by organizational personnel. The records having the information may not be stored on a database of the present system, but instead may be retrieved from a separate source (such as a database hosted on an organizational human resources server) and used transiently in the present system in achieving the aim of identifying relevant personnel of the organization.

The database is operably connected to a central computer 200 via an I/O interface 210, the computer having a local storage device 220 and memory 230 having computer-executable instructions for executing the computer-executed actions required, an AV interface 240 operably connected to a display device 250, and a processor 260, all operably connected to a communications bus 270. The system includes a remote computer 300 which is operably connected to the central computer 200 via a network interface 280. Both central computer 200 and remote computer 300 are disposed within a firewall of the organization.

In another aspect an embodiment of the present invention provides a computer-implemented method for sharing information held by personnel within an organization, the method comprising the steps of obtaining information on one or more personnel of the organization, the information relating to a knowledge, skill or experience of the one or more personnel, entering the information into a database such that the name and/or contact details of the one or more personnel is linked to the relevant personnel's information, and optionally interrogating the database for a desired information, and where the desired information is held by one of the one or more personnel the name and/or contact details of the personnel holding the desired information is displayed.

In one embodiment the structured questionnaire is presented to the one or more personnel of the organization at the commencement of employment and/or at regular intervals during employment.

In one embodiment the structured questionnaire is structured by way of a set of predetermined questions.

In one embodiment, one or more question(s) of the set of predetermined questions is presented with a set of multiple choice answers.

In one embodiment the information is not social-related information.

In one embodiment the method includes the step of a user completing a log in step prior to grant of access to the database.

In one embodiment, a user is identifiable.

In one embodiment the database is configured such that it is searchable for the information held by the one or more personnel by keyword(s), or system-defined lexicological equivalent(s) thereof.

In one embodiment the database is configured such that it is searchable for the information held by the one or more personnel information by an explicit request for information, or in the form of a problem, a hypothetical scenario, or a case study.

In one embodiment, the method comprises use of a system described herein.

In a further aspect an embodiment of the present invention provides a database for accessing information held by one or more personnel within an organization, the database being operably connected to a private computer network of the organization, the database comprising: (i) information held by one or more personnel of the organization, and (ii) contact details and/or name(s) of the one or more personnel, wherein the information and contact details and/or names are linked.

An embodiment of the present invention is proposed to be useful in collecting and retaining the collective knowledge, skills and experience of personnel in an organization. Where information is sought by way of computer-based forums detailing a problem, issue or idea such exchanges between users can be retained for future reference. These exchanges can be useful in data mining to problem solve similar problems, address similar issues or advance similar ideas at a later date. The information may also be mined by senior management of an organization with the aim of identifying particularly innovative or knowledgeable employees, or suitable candidates for vacancies in an organization.

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out one or more embodiments of the invention.

It will be appreciated that in the description of exemplary embodiments of the invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following are hereby expressly incorporated into this Summary section, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described embodiments of the invention, those skilled in the art will recognize that other and further modifications may be made thereto without departing from the spirit of the invention, and it is intended to claim all such changes and modifications as fall within the scope of the invention. Functionality may be added or deleted from the block diagrams and operations may be interchanged among functional blocks. Steps may be added or deleted to methods described within the scope of one or more embodiments of the present invention.

Although embodiments of the invention has been described with reference to specific examples, it will be appreciated by those skilled in the art that the invention may be embodied in many other forms.

One or more embodiments of the present invention will now be more fully described by reference to the following non-limiting examples.

### Example 1: Employee Recruitment—Database Entries

A multinational pharmaceutical corporation having in excess of 80,000 personnel recruits a new full-time employee. Upon commencement, human resource officer enters the following data relating to the new employee into a database:

| FIELD | ENTRY |
|---|---|
| Name: | DOE, John |
| Home Address | 21 Elm Street, Metropolis, CA. |
| Citizenship | United States |
| Qualification(s) | Bachelor of Science (Biochemistry) |
| Position | Research and Development Scientist |
| Current Salary | USD85,000.00 |
| Next Salary Review | May 2013 |
| Work Physical Address | Laboratory 5.05, level 5, R&D complex |
| Work email address | jdoe@pharmacompany.com |
| Work telephone number | +1 6975 5670 |
| Work Skype address | jdoe.pharmacompany |

In addition, the human resources officer (or authorised personnel) enters data that has been obtained from the new employee by way of structured interview.

| FIELD | ENTRY |
|---|---|
| Previous organization(s) | World Wide Therapeutics, Inc |
| (entered by free text) | |
| Previous position(s) | Process scale up validation scientist; |
| (entered by free text) | regulatory affairs associate |
| Native language | English |
| (selected by drop down menu) | |
| Other languages | French (technical) |
| (selected by drop down menu) | |
| Technical skills | Chromatography, protein purification, |
| (selected by drop down menu) | bioassay development |
| Business Skills | Negotiations on bulk supply of |
| (entered by free text) | chromatographic media |
| Other skills | Practical mechanical engineering skills |
| (entered by free text) | obtained while process validation |
| | scientist; including machining stainless |
| | steel fittings for use in pilot scale up work. |

The data is entered by the human resources officer (or authorised personnel) into a Microsoft SQL database hosted on the company's enterprise network. The data is entered by way of a web browser interface.

### Example 2: Searching Employee Database for Personnel Having Predetermined Skill Set

A production manager in France is faced with a problem of increasing production volume, and has hit a problem with finding stainless steel fittings for a custom made chromatography column. The issue is commercially sensitive because a production problem may lead to a competitor informing the market about potential supply problems.

The production manager has no person with the relevant scientific, engineering and regulatory skills. The manager has had meetings with representatives of the French R&D team, process scale up team, and regulatory affairs team but has not found a solution.

The manager interrogates the database with the following keywords:
“process”
“scale up”
“stainless”
“fitting”
“regulatory”
“French”

In response, the database returns all database details for John Doe, except for salary details. The production manager contacts John Doe via Skype to discuss his problem. John's fluency in technical French leads to a number of suggestions.

Before contacting John Doe, the production manager is not aware that his company has engineering expertise. This is normally contracted to external providers on a case-by-case basis.

### Example 3: Employee Updating Skills

After 12 months employment, an automatically generated email reminder prompts John Doe to update details on his knowledge, skills and experience. He logs into the system by way of a dedicated browser-based front end to review his information. He is not permitted to change any field, except for the following:
Language skills
Technical skills
Business Skills
Other skills

John amends the “other skills” field to include specific engineering outcomes devised in assisting in finding a solution to the French production manager's problem. He also been studying Spanish at a community college after work, and has added “Spanish (rudimentary)” to the language skills field.

### Example 4: Referral of Customer Need to an Organization

The present system is configured to provide a ‘Referrals’ function to manage process (workflow) within an organization. In this embodiment, the system is configured to receive a user request, and automatically route the request to a worker (or the worker's workflow queue) whereby the worker (by the search facility of the present system) is identified as having the appropriate characteristics (such as skill and information) to satisfactorily address the request. The system is configured so as to ensure a query is appropriately routed by the workflow system, considered by the identified worker and actioned. The workflow then passes the request to third party specialist software for processing through to completion. The system generates reports, provides data for analysis, and tracks each and every action against time en route.

Matching need to people and people to need is one aspect of the present system. By applying the above described query routing capability, the present system may comprise its own workflow management system that enables a user request (the user may be a customer, an employee, a member of a private network, etc who is part of the private network or is an authorised member of such a network whose database is contained, organised and searched by the present system), to search for and automatically route a user-generated or user-selected request or search to either: a) a particular individual that the present system has automatically identifies (by reference to the system database) as best suited to meet or fulfil a user-generated need (searched for), or b) to a group of individuals that the present system identified as suited to meet or fulfil a user-generated need, or c) to a workflow queue defined by the organisation to handle such requests or needs. Reference is made to FIG. 2B which shows the duplex exchange of information (via an API) between the present system and a workforce management system (WFM). The WFM system may be considered as discrete and separate from the system, or alternatively as a component of the present system.

With respect to a) b) and c) the need or request is defined by a single user, who may be within or external to the organisation. For example, the user may be an employee or a customer or a member, depending on how the private network definition has been set up in the present system.

The need or request may be captured in various ways but may include the need or request originator (being a user who can access the present system) making a selection of a need or request from a list, or by entering a natural language description of that need or request.

The present systems routing function then ensures that the request or need automatically reaches the inbox or inboxes of the individual(s) best suited to deal with the need or request. Alternatively, the individual(s) is/are alerted to the request or need by way of a remote and optionally processor-based device such as a smart phone. The device may comprise application software configured to receive a notification by wireless means (such as a cell phone based data network) and display a notification on the device screen.

In this embodiment, the present system tracks and monitors the process from the time an originator inputs the request to the point where the individual identified to address the request assumes responsibility for responding to the original request and either deals with it in full or in part before handing it off automatically via the system to an enterprise or specialist third party software system that completes the process. The third party software system may be a CRM (e.g. Saleforce™, Siebel™) of the organization which is configured to facilitate the ongoing customer relationship or sales process.

In one embodiment of the present system, a user who has become aware of a customer request (directly, or indirectly by interaction with another person or computing device) can input the request into the Referrals function of the present system.

In the Referrals function, a user (who the system automatically identifies by way of login details), can select from a number of options and enter into a text input box, in natural language, a description of the need. The types of information captured can be various and is not limited to the above but may include any one or more of: user identification, user contact details, the time that the need was entered, the contact details of the individual who requires help or services (the customer), and the value of the potential business in currency terms (for example, dollar terms).

### Example 5: Specific Application of Referrals Function for Handling a Sales Lead

An individual in a banking organisation picks up a ‘warm lead’ for a new business opportunity in relation to a banking service provided by the bank. The individual considers that the customer has a need which can be addressed by a banking service. The individual does not know to which member of the bank staff to forward a request to assume responsibility for the lead and convert the lead to new business.

Accordingly to this exemplary embodiment of the present system, the individual enters a natural language description of the customer need in the form of a request. By reference to the system database, the request is automatically matched to one or more individuals at a customer-acceptable location who deal with similar requests and has been authorised to do so. The present system then automatically routes the request to one or more potential responders and the request appears in his/her/their inbox. The first responder to open their inbox and accept the opportunity or request by clicking on a button is now responsible for actioning it. He or she is now the ‘owner’ of the opportunity or request.

Once the opportunity has been accepted, it disappears from the inbox of all other staff members who were sent the request to respond but failed to be the first to do so and have now missed out.

The individual who owns the opportunity or request can view the full request including who entered it (the originator), their contact details, and the description in natural language in relation to the customer need.

From the time the individual accepts responsibility, the system is configured to monitor time taken for the individual to action and optionally resolve the request. The present system keeps track of the date and time of acceptance, and the elapsed time until the customer need is resolved, or the individual's portion of an overall task is completed (such as when the individual clicks ‘submit’ and the request is passed on to third party software for further processing).

An acceptable time to process a request may be entered into the system, and may be prescribed by the organization according to an internal service level requirement.

In terms of management of the workflow, authorised managers and executives may view individual or group summary information via online reporting or by printing out of reports, detailing the time elapsed since any one request or series of requests was first received, was accepted, who is responsible, the date and time from time of acceptance to the date and time of completion (for example, submission to third party software for completion and processing through to close of matter). Managers and executives may be enabled by the system to contact an individual involved in meeting the customer need, monitor, manage and enquire on progress. The information may be used by further software means to forecast revenue, sales, etc.

Applicant proposes that significant amounts of revenue that may otherwise be lost can be captured by the present system's routing function applied in this way. Thus, a warm lead is not lost simply because a member of bank staff does not know which other member of bank staff is capable of addressing a customer need.

This function can be used for many purposes in addition to capturing warm leads. It can be used for requesting information, making specific business requests for knowledge and help, providing customer assistance, capturing customer orders and so on.

### Example 6: Application of Routing Function in a Logistics Management System

This exemplary embodiment is directed to the use of a request routing function as part of a customer service fulfillment scenario in the context of a Logistics Management System. The customer request may be entered either via the third party software and passed on automatically (by virtue of the third party software being integrated with the present system), or via a user interface of the present system. The user interface could be presented on a mobile device or a desktop PC, via the internet, via a contact centre or some other capture modus. In any event, the customer request is identified by what the customer requires (for example delivery and installation of a product, fix or maintain an item of equipment, provide a specific service, answer a question or handle a complaint. These categories of request are identified in the present system's taxonomy and named accordingly based on an organization's offerings. For instance, if the offering is a physiotherapy service in the home, and specifically post-surgery physiotherapy, the present system may be configured to offer that choice to the customer. The customer can in some instances add a narrative in natural language and this is also captured.

As another example, if the organizational offering is fixing a type of computer network issue or installing a particular computer networking router, then the present system (by way of user interface) will offer those choices to the customer who can then select the required service.

In circumstances where a contact (call) centre is used, then the contact centre employee will identify the customer need by selecting from offerings provided by the present system according to the customer's business.

The categories of offering and degree of granularity of those offerings are fully customisable and are managed by the logic of the taxonomy incorporated into software of the present system.

### Example 7: System Integration with Logistics Software Platform

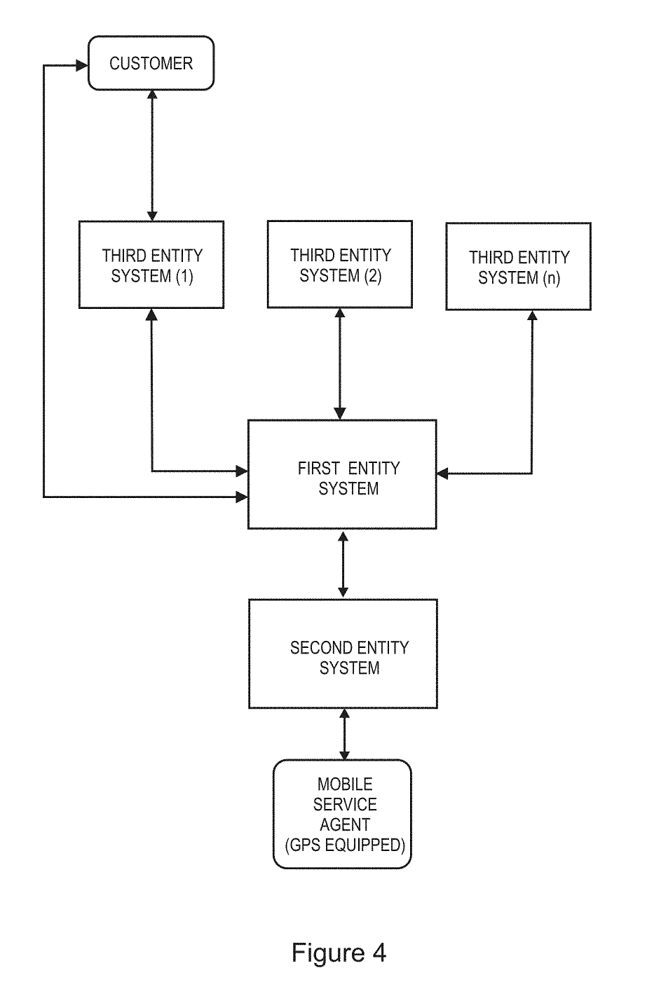

Reference is made to FIG. 4.

This example relates to the present system (operated by a first entity) integrated with a logistics management software platform (operated by a second entity). The first and second entities cooperate so as to deliver a product and/or service of a provider (being a third entity) to a consumer.

A plurality of third entities are involved in this example, each having a particular product and/or service offering. The first entity system has stored (or available to it at least on a transient basis) the various product and service offerings of each of the third entities. The group of third entities that are associated with the first entity may be considered unitarily as member entities of the first entity.

The products on offer by the third entities are typically those that rely on specialist personnel having a skill, knowledge, experience, qualification, or certification to effect tasks such as installation, maintenance, repair, and training in relation to the product.

The services on offer by the third entities typically involve tasks that rely on specialist personnel having a skill, knowledge, experience, qualification, or certification. In some instances the service provided by a third entity relates to a product supplied by that same third entity. In other instances, the service is a standalone service that does not relate to any particular product, much less any particular product of the third entity.

The system of the first entity is configured to receive the initial product/service request from a customer, typically via input on a user interface. The customer transmits and electronic request for specific product(s) and/or specialist service(s) to a third member entity (i.e. a member organization, group or network). The request may be transmitted by a requestor online or via a digital device or via the internet or via third party software or any other method deemed suitable for request transmission.

Alternatively the request may be transmitted via a call centre operator or a person of the third entity having a sales function, or via some other authorised person of the third entity.

In the first instance, the requestor selects whether they require a product or service or a combination, whether singular or multiple.

The requestor is offered via user interface, options in the form of categories relating to their selected products and/or services that the third entity has defined as their offering(s). These are stored in tables or in the lexicon and offered as drop down lists to the requestor.

For example, ‘Ysio Max Digital Xray machine’ could be one product description, and ‘XR656 Advanced Digital Radiography System’ could be another.

A next level of refinement could be, against Ysio, ‘Advanced Systems’; while against XR656 the drop down refinement could be ‘Stitching function’. The drop downs offer greater granularity and the lexicon is configured such that the system “intelligently” recognises (optionally via algorithmic means) the requestor's terminology as same or similar.

The requestor selects from the options via user interface.

The product and/or service lists are defined by the third entity, and are specific to the offerings of the third entity. The lists are loaded at time of implementation but can be changed and amended over time by those permitted by the system to do so.

The requestor is also asked via user interface to select the term/s that best describe the activities associated with those product/s and/or service/s and that best meet their needs such as ‘install’, ‘fix’, ‘update’.

For example, the associated activity may be to ‘fix’ or it could be to ‘fix’ [and] ‘update’.

In another example, the associated activity may be install, [and] update, MSQL database.

In another example the associated activity might be: ‘Help’ and ‘Advise’ where the service is aged care at home. Further dropdowns of the user interface menu may offer ‘dressing’, ‘bathing, ‘house work’ in relation to ‘Help’. In relation to ‘Advise’, the drop downs might be ‘Pain relief’ and ‘Sugar levels’.

By algorithmic means comprised in the system of the first entity, a matrix of facets is created on the fly in terms of the offering and these are referenced and matched to an equivalent matrix of facets relating to individual skills, experience, knowledge and so on of skilled individuals in the database.

The relationships between requests and the capabilities of the individuals available to execute the required work are maintained and managed algorithmically.

In some embodiments, once the initial product/services have been identified and the associated activities indicated, as described elsewhere herein, a requestors may also be able to enter free text in natural language further describing their requirements.

The system of the first entity stores, or has available to it, personnel-related data pertaining to the employees, associates, contractors or freelancers or any other people whose data the third entities, have permitted to be held in the system's database or have made available to it.

The people-related data is prescribed, as explained elsewhere herein.

Against every product or service, the third entity can specify the skills, knowledge, experience, qualifications, certifications required in relation to fulfilling the request. These may be stored in linked tables or in the lexicon. The skills, knowledge, experience, qualifications, certifications categories can be added to or amended by an authorised person. For instance, a minimum customer rating requirement may require periodic update

The system of the first entity matches the request to those personnel in the database who are best equipped to deliver the specialised or specialist services on behalf of the third entity which has received the request. This matching is performed ‘on the fly’ in response to each request.

The third entity is enabled to determine by adding further search terms whether or not it has sufficient numbers of people with the capabilities, qualifications etc. to execute the task-related service.

The closest matches are identified together with a location. For instance, ‘Environmental engineer, waste water treatment, BChem, min 3 years, in or near Seattle.’

The matches can then be handed-off and digitally shared with the second entity (being a third party logistics management platform), with the best matches listed first and then in descending order of relevance.

This list may be presented online via user interface, or as a printed report, or in csv format or passed on digitally in some other way. The second entity system further refines the location data by specifying an address for delivery of the product/s and/or service/s, together with other criteria necessary to its platform such as ‘time to destination’, allocates the work, tracks the progress of the personnel delivering it, keeps the end customer informed of progress and so on through to completion of the task. In this example, the second entity may be considered a “last mile” logistics provider.

The customer may receive an online request transmitted from the first entity system to rate the quality, timeliness or some other satisfaction criteria attached to the product and/or service. This feedback can be added to the data against each personnel in the database described and can be searched, mined, viewed and reported on.

In this embodiment, the system automatically tracks every input and output by date and time.

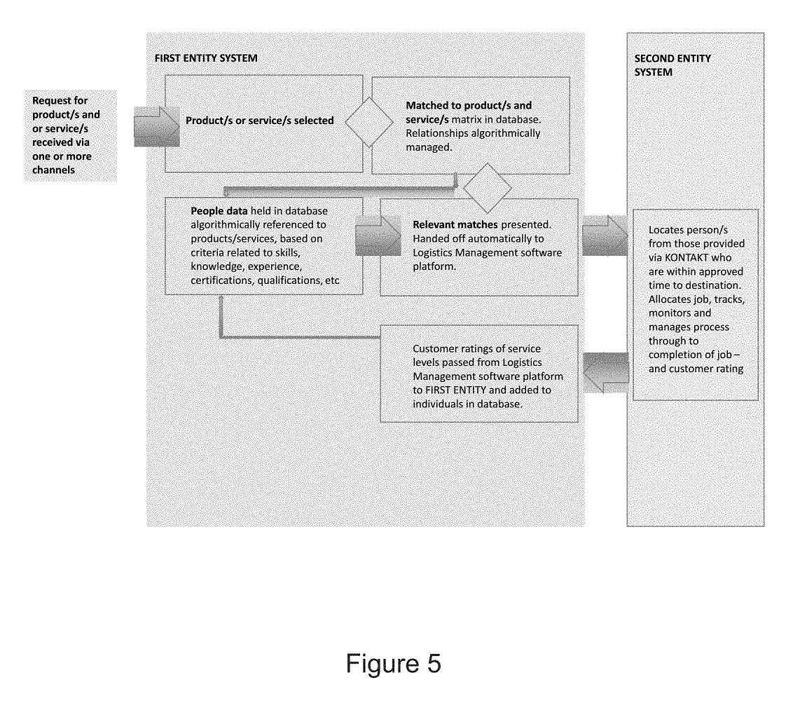

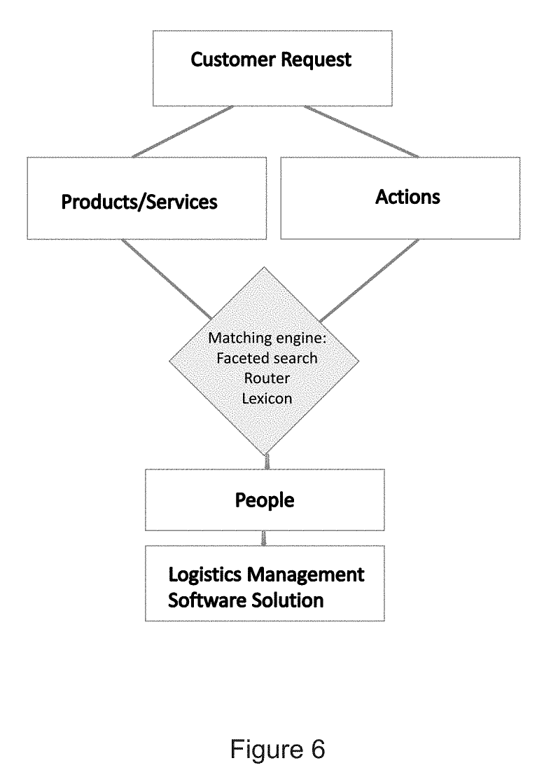

Reference is made to FIGS. 5 and 6 which provide further explanatory representations of the embodiment of this example.

### Example 8: System Configured to Provide Customer Ratings of Goods/Services Supplied by an Organization

In an exemplary situation, a third party logistics management software system may directly request feedback (via a user interface) from a customer. Alternatively, the system may be configured to otherwise determine the quality of the delivered service, either immediately on completion of the service by automatic message to the customer or some other modus (for example, an electronic survey) or at some other time. Customer feedback information may be automatically uploaded into the present system database and linked to the individual who delivered the service.

The feedback may be provided by way of a visual five star rating or selection from, say, 0-5, or text-based ratings such as, ‘not good’ ‘ok’ ‘excellent’ or from, say, ‘poor’ ‘ok’ ‘good’ ‘very good’ ‘excellent’.

For convenience of the user, the feedback information may be provided by way of user interface presented on a smartphone.

Feedback information assists in building a view of individual and overall team performance. The raw feedback information (or any proceed information derived therefrom) may be viewed by authorized persons within the organization, either by direct interaction with a user interface of the present or via an integrated or API-connected third party software user interface such as found in logistics software or in a workforce management or in human resource system.

The feedback information is of value to an organization as it provides for use by an authorized user for analytics and reporting on quality of service against a range of criteria. For example, the quality of service at an individual level in the moment and over time, whether there are sufficiently high quality or appropriately skilled service providers in a location when needed, locations where service does not meet quality requirements or does not meet customer needs, individuals who receive negative or unacceptable ratings and those who receive high quality customer approval ratings, where training may be indicated, where more or fewer resources need to be allocated and so on.

1. A system for identifying personnel within an organization, the personnel being identifiable by reference to a knowledge, skill, experience, or information held, the system being implemented on a computer network of the organization, the system comprising:
(A) a database configured to connect to the computer network, the database comprising
(i) knowledge, skill, experience or information held by one or more personnel of the organization, and
(ii) contact details of the one or more personnel; and
(B) one or more processor-enabled devices configured to connect to the computer network, the one or more processor-enabled devices configured to search the database,
wherein the system is configured to allow one or more processor-enabled devices to interrogate the database for a desired knowledge, skill, experience or information held, and where the desired knowledge, skill, experience or information, is held by one of the one or more personnel the one or more devices provided with the identification and/or contact details of the personnel holding the desired knowledge, skill, experience or information.

2. The system of claim 1, wherein the network of the organization is a private network configured such that it is not accessible by a processor-enabled device that is not owned, operated, controlled or administered by the organization.

3. The system of claim 1, wherein the network of the organization is implemented completely within a firewall of the organization.

4. The system of claim 1, wherein the knowledge, skill, experience or information held by the one or more personnel of the organization is obtained by a method which is at least partially controlled by the organization.

5. The system of claim 1, wherein the method of obtaining the knowledge, skill, experience or information comprises presentation of the one or more personnel of the organization with a structured questionnaire.

6. The system of claim 5, wherein the structured questionnaire is presented to the one or more personnel of the organization at the commencement of employment and/or at regular intervals during employment.

7. The system of claim 6, wherein one or more question(s) of the set of predetermined questions is presented with a set of multiple choice answers.

8. The system of claim 1, configured such that the database is configured such that it is searchable for the knowledge, skill, or information held by the one or more personnel by keyword(s), or system-defined lexicological equivalent(s) thereof.

9. The system of claim 1, wherein the database is configured such that it is searchable for the knowledge, skill or information held by the one or more personnel by an explicit request for information, or in the form of a problem, a hypothetical scenario, or a case study.

10. The system of claim 1, wherein the database comprises the geographical location or geographical region of personnel so as to allow for personnel to be searched according to geographical location or geographical region.

11. The system of claim 1, comprising a data feed providing substantially real time information on the geographical location of personnel so as to allow for personnel to be searched according to geographical location or geographical region.

12. The system of claim 11, wherein the system comprises one or more mobile devices in operable connection therewith, each of the one or more mobile devices being location-enabled such that each of the one or more mobile devices contributes to the data feed.

13. The system of claim 1 in operable connection with a logistics management system configured to manage the delivery of a product and/or a service to a site.

14. The system of claim 13 configured to select one or more mobile personnel to travel to at a site where a product and/or service is to be delivered, wherein the selection is based on a skill, knowledge, information or experience required for a task to be executed at the site and optionally geographical location of the personnel

15. The system of claim 14 comprising a database configured to connect the computer network, the database comprising:
(i) task-related knowledge, skill, experience or information held by one or more personnel of the organization,
(ii) identification and/or contact details of the one or more personnel; and optionally
(iii) geographical location information of the one or more personnel,
wherein the system is configured to allow for interrogation the database for one or more personnel having a desired task-related knowledge, skill, experience or information for a service required at a site, and where the desired task-related knowledge, skill, experience or information is held by one of the one or more personnel the system provides the identification and/or contact details of the personnel having the desired task-related knowledge, skill, experience or information.

16. The system of claim 13 comprising one or more remote location-enabled devices configured to connect to the private computer network, the one or more remote location-enabled devices configured to be carried by the one or more personnel and to detect the geographic location of the one or more personnel, wherein the geographical location information of the one or more personnel of the database is obtained from the one of more location-enabled devices.

17. The system of claim 13 comprising a computer-implemented personnel management or communication system that:
(i) is in operable communication with the system and/or the system database,
(ii) forms the database,
(iii) forms part of the database,
(iv) is an intranet, or
(v) is an email system

18. The system of claim 17 wherein the computer-implemented personnel management system is selected from a group consisting of a human resources system, a customer relationship management system, a personnel recruitment management system, a logistics management system, a workforce management system, an active directory system, a learning management system.

19. A computer-implemented method for identifying one or more mobile personnel for deployment to a work site, the method comprising the steps of obtaining information on one or more personnel of the organization, the information relating to a task-related knowledge, skill or information held by the one or more personnel and a geographical location of the one or more personnel, entering the information into a database such that the identification and/or contact details of the one or more personnel is linked to the relevant personnel's information, and optionally interrogating the database for a desired task-related knowledge, skill or information, and where the desired task-related knowledge, skill or information is held by one of the one or more personnel the identification and/or contact details of the personnel having the desired task-related knowledge, skill or information is displayed or passed on for dispatch.

20. A computer-implemented method for sharing information held by personnel within an organization, the method comprising the steps of obtaining information on one or more personnel of the organization, the information relating to a knowledge, skill, experience or information held by the one or more personnel, entering the information into a database such that the identification and/or contact details of the one or more personnel is linked to the relevant personnel's information, and optionally interrogating the database for a desired knowledge, skill, experience or information, and where the desired knowledge, skill, experience or information is held by one of the one or more personnel the identification and/or contact details of the personnel holding the desired knowledge, skill, experience or information is displayed.
